(19) United States
(12) Patent Application Publication
(10) Pub. No.: US 2008/0131185 A1
(43) Pub. Date: Jun. 5, 2008

(54) MULTI-ROLL PAPER SUPPLY FOR PRINTER

(76) Inventor: Jay Hyuk Kim, Raleigh, NC (US)

Correspondence Address: DUKE W. YEE;YEE & ASSOCIATES, P.C., P.O. BOX 802333, DALLAS, TX, 75380, US

(21) Appl. No.: 11/565,226

(22) Filed: Nov. 30, 2006

(51) Int. Cl. B41J 11/50

(52) U.S. Cl. 400/605

(57) ABSTRACT

Apparatus supplies a printer used in a POS location or other printer station with paper from two different rolls. A detection device recognizes when the feeding roll is about to run out of paper, whereupon the paper feeding task is automatically switched to the other roll. An operator only needs to service a printer station before both rolls of paper run out in order to prevent a downtime. One embodiment is directed to apparatus for supplying paper to a printer disposed to receive paper from either a first or a second paper roll. The apparatus comprises first and second roller sets corresponding to first and second paper rolls, respectively, each roller set being operable when receiving power to supply paper from its corresponding paper roll to the printer. The apparatus further comprises a single power source, and a power delivery mechanism for adapting the first and second roller sets to receive power from the source during first and second operating modes, respectively, of the mechanism. A device is provided to monitor the amount of paper remaining on the roll feeding the printer, and to direct the mechanism to change modes before the remaining amount runs out.

### BACKGROUND OF THE INVENTION

1. Field of the Invention

The invention disclosed and claimed herein generally pertains to an apparatus and method for enabling a printer to be supplied with paper from either of two or possibly more rolls. More particularly, the invention pertains to apparatus of the about type wherein paper being supplied to the printer is automatically transferred from one roll to the other. Even more particularly, the invention pertains to apparatus of the above type wherein transfer between rolls occurs upon sensing that the roll feeding the printer is about to run out of paper.

2. Description of the Related Art

In stores and other shopping areas, it has become common to have printers located at point-of-sale (POS) terminals or locations, such as in kiosks, at check out counters, and the like. Each time a clerk or store employee rings up a sale, a computer-operated printer rapidly prepares a customer receipt, from paper contained on a roll. Customers can thereby be provided with paper records for all transactions, in a manner that is efficient and inexpensive. As a further example, printers are commonly used with paper rolls in theaters or other sites requiring admission, to print and dispense tickets.

A drawback in using printers of the above type is that paper rolls must be periodically replaced, when the paper on respective rolls runs out. In a commercial environment, it can be very inconvenient to have a printer roll run out of paper at a time of great activity, such as when numerous customers are waiting for service. A need to change printer rolls at a kiosk in a shopping mall or the like may be particularly troublesome, when there is only a single sales clerk to respond to customers, watch over merchandise and otherwise take care of business.

At present, the above situation is commonly dealt with by requiring an operator in a business establishment to be on call, in order to refill respective printers when they run out of paper. Most printers currently have paper-low and paper-empty sensors. Some even have means to send a message via Ethernet, to notify the operator to come to the printer and refill it with a new paper roll. However, if the operator comes too early, before the paper supply completely runs out, the remaining roll will be thrown away with useable paper still on it, in order to insert a new roll. On the other hand, if the operator comes too late, the kiosk or other POS location would have experienced down time during which it was not able to service customers.

### BRIEF SUMMARY OF THE INVENTION

Embodiments of the invention generally provide a printer used at a kiosk or other POS location with two or more rolls of paper. A detection device is positioned to recognize that a roll being used to feed the printer is about to run out of paper, whereupon the paper feeding task is automatically switched to another roll. Thus, instead of being on call or waiting for notification from respective kiosks, an operator can simply make routine maintenance visits to respective POS locations, to replace any empty rolls of paper. The operator would only have to service a printer station before both rolls of paper run out, in order to prevent a downtime. Using this solution will significantly relieve or eliminate problems of the type described above, and will cut down on the cost of maintenance by reducing the amount of work an operator has to do for each printer. This, in turn, will enable the operator to manage a larger region and more POS printer stations. One embodiment of the invention is directed to apparatus for supplying printing paper to a printer that is disposed to receive paper from either a first paper roll or a second paper roll. The apparatus comprises first and second roller sets corresponding to first and second paper rolls, respectively, each roller set being operable when receiving power to supply paper from its corresponding paper roll to the printer. The apparatus further comprises a single power source, and a power delivery mechanism for adapting the first and second roller sets to receive power from the source during first and second operating modes, respectively, of the mechanism. A device is provided to monitor the amount of paper remaining on the roll feeding the printer, and to direct the mechanism to change modes before the remaining amount runs out.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram showing an embodiment of the invention.

FIG. 2 is a schematic diagram showing a further embodiment of the invention.

FIG. 3 is a schematic diagram showing a configuration of rollers for feeding paper in the embodiment of FIG. 2.

FIG. 4 is a schematic diagram showing a locking mechanism for the embodiment of FIG. 2.

FIGS. 5A-5C are schematic diagrams showing respective modes of yet another embodiment of the invention.

### DETAILED DESCRIPTION OF THE INVENTION

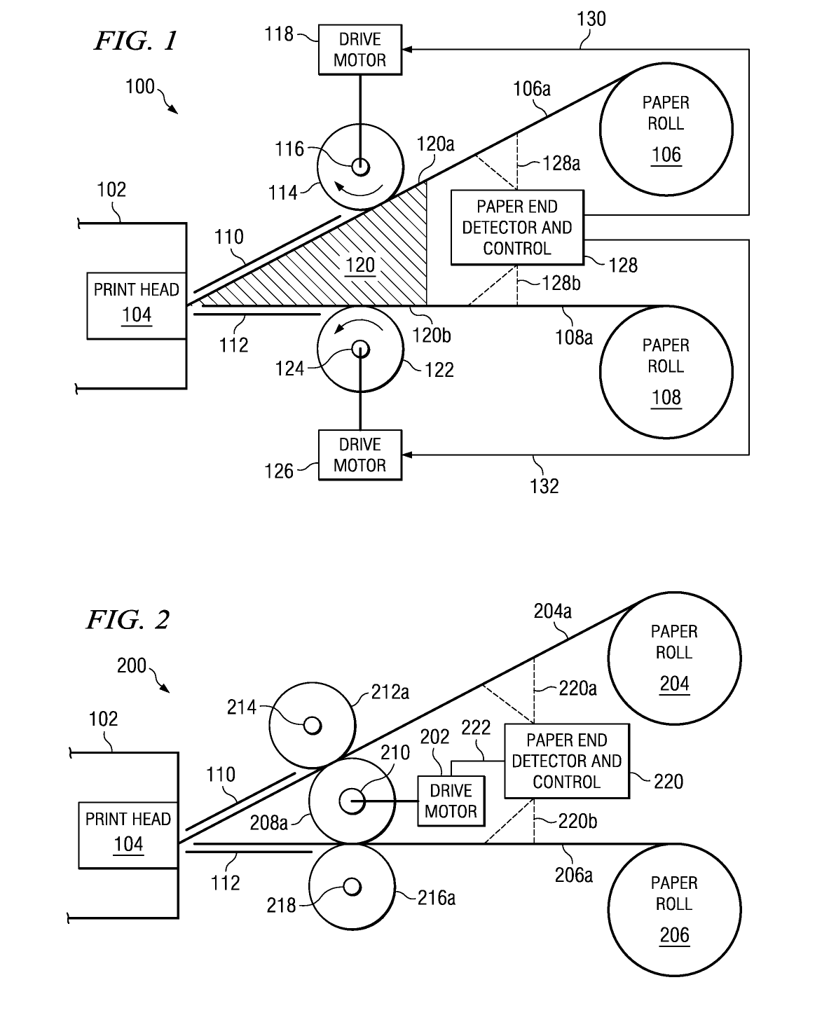

Referring to FIG. 1, there is shown a paper feeding apparatus 100 in accordance with an embodiment of the invention, for use in association with a printer 102 (shown only in part). Printer 102 has a print head 104, which is disposed to receive either paper 106a from a paper roll 106, or paper 108a from a paper roll 108. FIG. 1 shows paper guides 110 and 112 for routing paper to print head 104, from either roll 106 or 108, whenever printer 102 is operated to print out needed material. Printer 102, by way of example and not limitation, may be located at a POS terminal in a kiosk or other commercial place of business, may be in a theater ticket booth, or may be connected for operation by a computer or data processing system.

While not shown in detail, a “paper roll” as used herein refers to a continuous strip of paper wound or rolled upon a roll, roller or tube that is mounted for rotation. Thus, pulling on an end of the paper causes the paper to be progressively removed from the roll.

Referring further to FIG. 1, there is shown a driver roller 114 that is mounted for rotation on a shaft 116, and is linked to receive power from a drive motor 118. Activation of motor 118 rotatably drives roller 114 in a clockwise direction, as viewed in FIG. 1, causing driver roller 114 to feed paper 106a of roll 106 to print head 104. To further achieve this feeding action, a back plate 120 provides a paper guide surface 120a in closely spaced relationship with roller 114. Driver roller 114 bears against the surface 120a through paper 106a. Thus, driver roller 114 engages paper 106a with sufficient frictional force to move the paper into print head 104, when driver roller 114 is rotated by motor 118.

In similar fashion, a driver roller 122 is mounted for rotation on a shaft 124, rotatably driven by a drive motor 126, and bears against a paper guide surface 120b of back plate 120 through paper 108a. Activation of motor 126 rotates driver roller 122 in a counterclockwise direction, as viewed in FIG. 1, to feed paper 108a into print head 104.

FIG. 1 further shows paper feeding apparatus 100 provided with a paper end detector and control device 128. Device 128 is configured to control the operation of driver rollers 114 and 122, by selectively activating motor 118 to drive roller 114, or activating motor 126 to drive roller 122. Thus, device 128 determines whether paper at any given time is being fed to printer 102 from paper roll 106 or 108. Device 128 can also switch between the two rolls in supplying paper.

Device 128 is further configured to use any available technique, as will occur to those of skill in the art, to detect that the paper on either roll 106 or 108 is almost at its end. For example, device 128 could project scanned beams 128a and 128b, in order to detect the occurrence of special bar codes on paper 106a and 108a, respectively. The special bar code would be placed toward the end of paper loaded onto each roll, to indicate that the paper on the roll is nearly used up. Thus, when device 128 is operating a particular roller driver to feed paper from its corresponding paper roll to the printer, detection of the special code would notify the device 128 that the paper on the roll was almost exhausted. Device 128 would then halt operation of the feeding driver roller and activate the other driver roller, so that paper would continue to be supplied to printer 102. Control signals are usefully coupled from device 128 to operate motors 118 and 126 through signal transmission paths 130 and 132, respectively. Device 128 could include a processor, and could be constructed using one of a number of approaches well known to those of skill in the art.

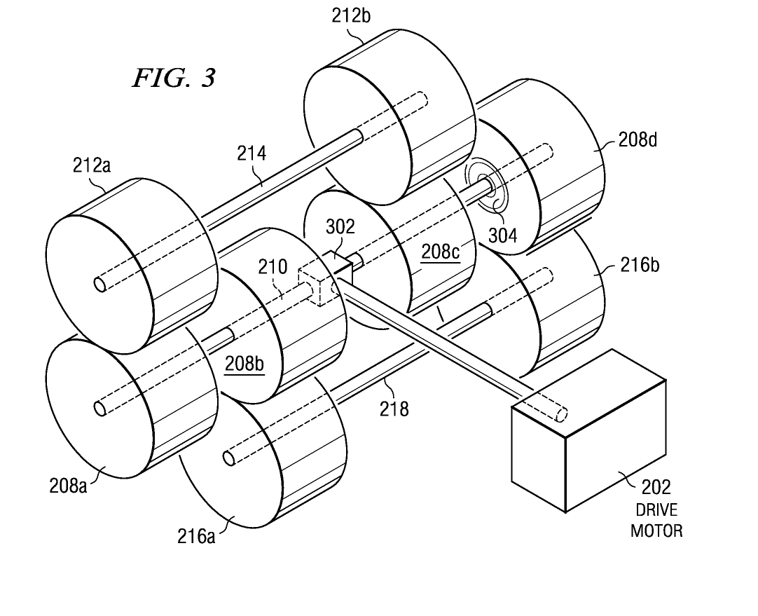

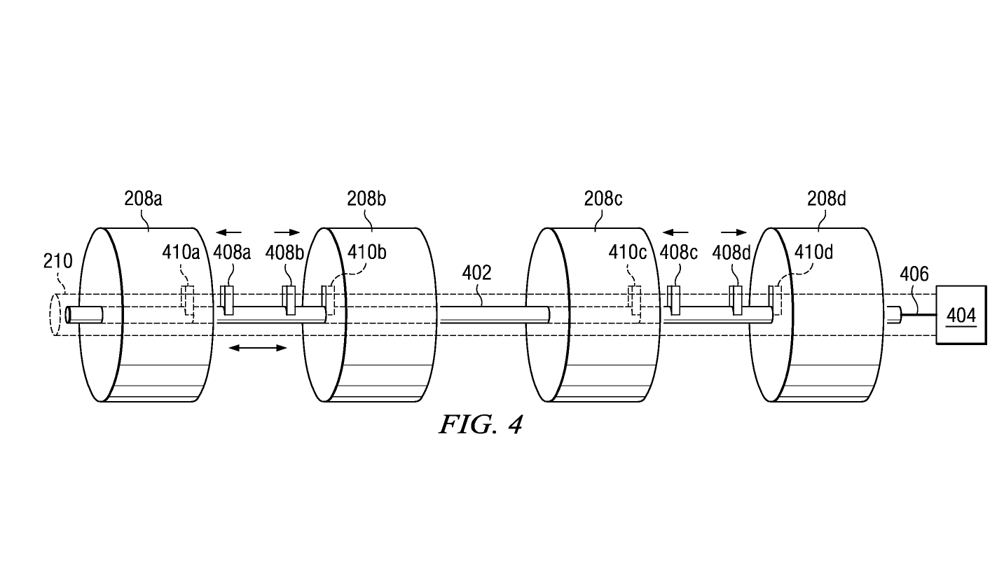

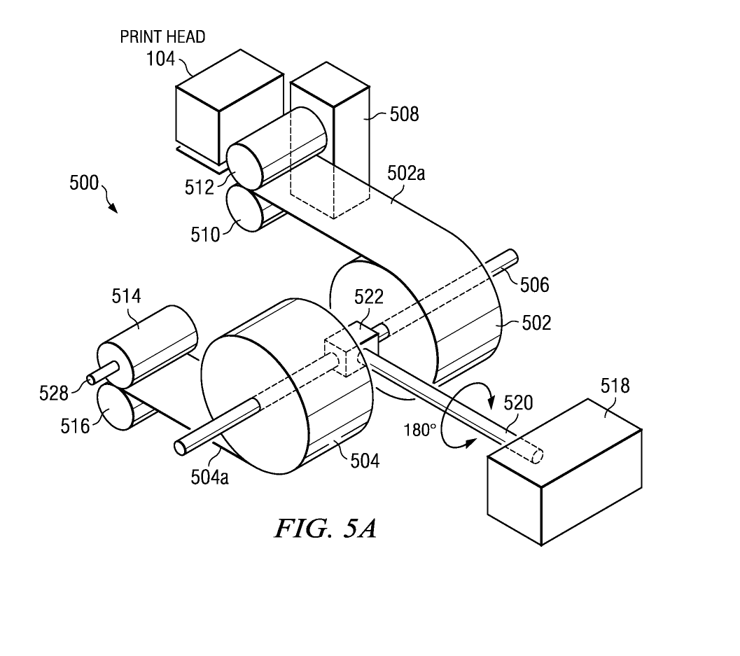

Referring to FIG. 2, there is shown an embodiment comprising a paper feeding apparatus 200 for supplying paper to print head 104 of printer 102. Apparatus 200 uses a single power source such as a drive motor 202, rather than the two motors of apparatus 100, in order to selectively feed paper to printer 102 from either paper roll 204 or 206. In apparatus 200 of FIG. 2, a number of driver rollers such as roller 208a are carried upon a power shaft 210, which is linked to motor 202 and rotatably driven thereby. When power shaft 210 is rotated in a counterclockwise direction as viewed in FIG. 2, one or more driver rollers on the power shaft, together with complementary passive rollers such as roller 212a on a shaft 214, act in cooperation to feed paper 204a of paper roll 204 to the printer 102. Similarly, when power shaft 210 is rotated in a clockwise direction as viewed in FIG. 2, one or more driver rollers on the power shaft, together with complementary passive rollers such as 216a on a shaft 218, act in cooperation to feed paper 206a of paper roll 206 to the printer 102. Driver rollers such as 208a, passive rollers such as 212a and 216a and shafts 210, 214 and 218, as well as their respective interactions, are further described hereinafter in connection with FIGS. 3 and 4.

FIG. 2 further shows paper feeding apparatus 200 provided with a paper end detector and control device 220, similar or identical to device 128 shown in FIG. 1. Thus, device 220 projects scanned beams 220a and 220b, in order to detect the occurrence of special bar codes at the ends of paper 204a and 206a, respectively. When motor 202 is rotating shaft 210 in one direction, to feed paper from the corresponding paper roll, detection of the special code would notify device 220 that the paper on the roll was almost exhausted. Device 220 would then operate motor 202 to rotate shaft 210 in the opposite direction, so that paper would be supplied to the printer from the other roll. Control signals are usefully coupled to motor 202 from device 220 through a signal transmission path 222.

Referring to FIG. 3, there is shown power shaft 210 and shafts 214 and 218 in spaced apart parallel relationship with one another, and each supported for rotation (by means not shown). Shafts 214 and 218 are able to rotate freely. However, power shaft 210 receives rotary power through a coupling 302, from drive motor 202 as described above. Power shaft 210 is rotatably driven in either a counterclockwise or clockwise direction, as determined by motor 202.

Referring further to FIG. 3, there are shown driver rollers 208a-208d respectively carried upon power shaft 210, in spaced apart relationship with one another. Driver rollers 208a and 208c are in contacting engagement with passive rollers 212a and 212b, respectively, mounted for rotation on shaft 214. Thus, when power shaft 210 rotates driver rollers 208a and 208c, rollers 212a and 212b are rotatably driven thereby, respectively. Moreover, when power shaft 210 rotates in a counterclockwise direction, as viewed in FIG. 3, and driver rollers 208a and 208c are likewise driven to rotate counterclockwise, paper 204a of paper roll 204 will be fed to print head 104 of printer 102. This is achieved by the collective action of the roller set comprising driver rollers 208a and 208c, and passive rollers 212a and 212b respectively driven thereby. It will be readily apparent that a roller set could have a different number of driver rollers and corresponding passive rollers than two, for engaging and feeding paper 204a.

Similarly, when power shaft 210 rotates driver rollers 208b and 208d, passive rollers 216a and 216b are respectively rotated thereby. Moreover, when power shaft 210 rotates in a clockwise direction as viewed in FIG. 3, driver rollers 208b and 208d are likewise driven to rotate clockwise. Accordingly, paper 206a of paper roll 206 will be fed to print head 104 by the collective action of the roller set comprising driver rollers 208b and 208d and passive rollers 216a and 216b, respectively.

In apparatus 200, each driver roller 208a-d is journaled on power shaft 210 by means of a rotary bearing, such as bearing 304 shown to support driver roller 208d. Thus, each roller driver is able to turn freely with respect to power shaft 210, and need not rotate therewith. In order to feed paper 204a for paper roll 204 to the printer, a locking device is provided as described hereinafter in further detail, in connection with FIG. 4. The locking device locks driver rollers 208a and 208c to rotate with power shaft 210. However, driver rollers 208b and 208d are not locked to the power shaft. Motor 202 is then operated to rotate power shaft 210 in a counter clockwise direction, as viewed in FIG. 2. Driver rollers 208a and 208c, and their respective corresponding passive rollers 212a and 212c, are thus driven to feed paper of roll 204 to the printer. Driver rollers 208b and 208d, on the other hand, are not constrained to rotate with power shaft 210, and no rotary force is supplied thereto by the power shaft.

In order to feed paper 206a from paper roll 206, driver rollers 208a and 208c are released by the locking mechanism, and driver rollers 208b and 208d are locked to power shaft 210 for rotation therewith. Motor 202 is operated to rotate power shaft 210 in a clockwise direction, as viewed in FIG. 2. Accordingly, driver rollers 208b and 208d and their respective corresponding rollers 216a and 216b are driven to feed paper of roll 206 to the printer.

Referring to FIG. 4, there is shown power shaft 210 comprising a hollow shaft containing a rod 402. Rod 402 is supported for limited reciprocal displacements within shaft 210, that is, movement to right and left as viewed in FIG. 4, over a specified range. Rod 402 is controllably reciprocated by a conventional actuation motor 404 that is attached to an end of shaft 210, and is coupled to drive rod 402 by means of a link 406. The operation of motor 404 is controlled by control 220 shown in FIG. 2.

Referring further to FIG. 4, there are shown keys 408a-408d respectively mounted on rod 402 for movement therewith, wherein keys 408a-408d correspond to driver rollers 208a-208d, respectively. Moreover, key ways or slots 410a-410d are formed in driver rollers 208a-208d, respectively, wherein each key way is sized to receive the key corresponding to its roller driver. A locking relationship may thereby be established between the driver roller and the shaft 210, through rod 402.

By providing the configuration of FIG. 4, driver rollers 208a and 208c can be locked to shaft 210 by operating motor 404 to move rod 402 leftward, as viewed in FIG. 4. Keys 408a and 408c are thereby inserted into key ways 410a and 410c, respectively. Shaft 210 can then be driven in a counterclockwise direction to feed printer 102 with paper from roll 204, as described above. In like manner, rod 402 is moved rightward, to insert keys 408b and 408d into key ways 410b and 410d, respectively. Driver rollers 208b and 208d are thereby locked to shaft 210, for rotation therewith. At the same time, keys 408a and 408c are withdrawn from key ways 410a and 410c, so that driver rollers 208a and 208c are released from shaft 210. Power shaft 210 may then be rotated in a clockwise direction, to feed printer 102 with paper from roll 206, as likewise described above. While not shown, various means well known to those of skill in the art may be used to align respective keys with their corresponding key ways, to facilitate insertion.

It is to be understood that numerous other arrangements for selectively locking and unlocking driver rollers with respect to shaft 210 will occur to those of skill in the art. All such arrangements are considered to be within the scope of the invention, and may include but are by no means limited to braking mechanisms and gear and sprocket arrangements.

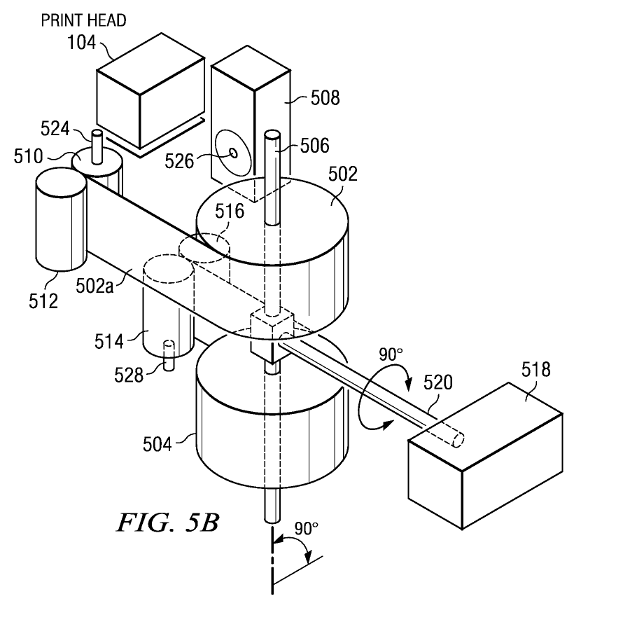

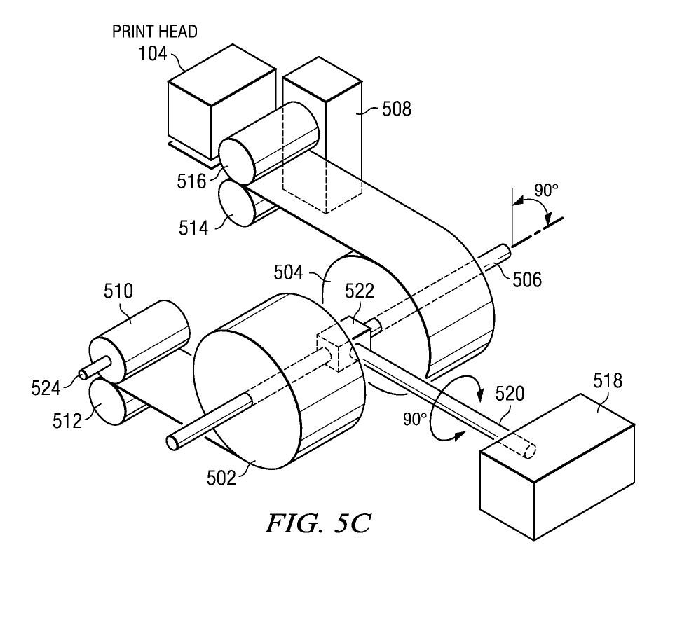

Referring to FIG. 5A, there is shown an apparatus 500 for supplying paper to a print head 104 of a printer from either a paper roll 502 or 504. Paper rolls 502 and 504 are both mounted on a common shaft 506, in coaxial relationship therewith and with one another. The apparatus 500 shown in FIGS. 5A-5C reduces the amount of space that is needed to accommodate the paper rolls, and at the same time requires only a single motor to feed paper to the print head from either paper roll 502 or 504. Apparatus 500 is provided with two roller sets, one set comprising a driver roller 510 and a passive roller 512 in engaged or closely spaced relationship, in order to feed paper 502a of paper roll 502 to the printer. The other roller set comprises a driver roller 514 and a passive roller 516, likewise engaged to feed paper 504a of paper roll 504 to the printer.

Referring further to FIG. 5A, there is shown a control and power source 518 provided to turn or rotate a power shaft 520 through an angle of 180°, around the axis of shaft 520. Shaft 506, carrying paper rolls 502 and 504, is fixably joined at its center to power shaft 520, by a hub 522 or the like. Thus, rotation of shaft 520 acts to rotate shaft 506 through an angle of 180° about the axis of shaft 520, which is orthogonal to shaft 506.

More particularly, shaft 506 can be rotated from the horizontal orientation shown in FIG. 5A, through the vertical orientation shown in FIG. 5B and to the horizontal orientation of FIG. 5C. The control and power source 518 can also rotate shaft 506 in the opposite direction. The paper rolls 502 and 504 mounted on shaft 506, as well as the roller sets comprising rollers 510 and 512 and rollers 514 and 516, respectively, are rotated with the shaft 506. Structure supporting shaft 506 for rotation, as well as structure joining the two roller sets for rotation with shaft 506, is not shown for simplicity of illustration but can readily be provided by those of skill in the art.

As shaft 506 is moved into the horizontal mode shown in FIG. 5A, driver roller 510 becomes mechanically linked to motor 508. In a useful embodiment, this is accomplished by attaching a driving element 524 to driver roller 510, as shown by FIG. 5B. When shaft 506 is rotated to the orientation shown in FIG. 5A, element 524 is inserted into a complementary receptacle 526 of motor 508. Thereupon, operation of motor 508 will drive rollers 510 and 512 to feed paper of roll 502 to the printer. Motor 508 is usefully operated by the control 518.

FIG. 5B shows that driving element 524 is withdrawn from receptacle 526 of motor 508, when shaft 506 is rotated from the horizontal mode of FIG. 5A. FIG. 5B further shows roller driver 514 of the other roller set provided with a driving element 528 similar to driving element 524.

When shaft 506 is oriented to the horizontal mode of FIG. 5C, driving element 528 of driver roller 514 is inserted into receptacle 526. Thus, operation of motor 508 will drive rollers 514 and 516 to feed paper of roll 504 to the printer.

It will be seen that power source and control 518, by selective rotation of shaft 506 and paper rolls 502 and 504, can readily transfer the task of supplying paper to the printer from one roll to the other. While not shown, a paper end detector such as detector 220, described above, can be positioned to sense that the paper on the supplying roll is almost gone. The detector would then notify control 518 to rotate shaft 506 and the paper rolls carried thereby, in order to switch the supply task to the other roll.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. For use with a printer disposed to receive printing paper from any of a plurality of paper rolls, apparatus for supplying paper to said printer comprising:
a roller set corresponding to each of said plurality of paper rolls, each roller set being operable when receiving power to supply paper from its corresponding paper roll to said printer;
a power delivery mechanism for adapting each roller set to receive power from said source during a corresponding operating mode, respectively, of said mechanism; and
a device for monitoring the amount of paper remaining on the paper roll supplying the printer at a given time, wherein said device is disposed to direct said mechanism to change operating modes before said remaining amount is used up.

2. The apparatus of claim 1, wherein said apparatus uses a single power source to supply power to each of said roller sets.

3. The apparatus of claim 1, wherein:
said apparatus supplies paper to a printer used at a specified point-of-sale terminal, or to a printer used in a specified data processing system, selectively.

4. For use with a printer disposed to receive printing paper from either a first paper roll or a second paper roll, apparatus for supplying paper to said printer comprising:
first and second roller sets corresponding to said first and second paper rolls, respectively, each roller set being operable when receiving power to supply paper from its corresponding paper roll to said printer;
a single power source;
a power delivery mechanism for adapting said first and second roller sets to receive power from said source during first and second operating modes, respectively, or said mechanism; and
a device for monitoring the amount of paper remaining on the paper roll supplying the printer at a given time, wherein said device is disposed to direct said mechanism to change modes before said remaining amount is used up.

5. The apparatus of claim 4, wherein said mechanism comprises:
a power shaft carrying at least one driver roller belonging to each of said first and second roller sets;
a first shaft parallel to said power shaft carrying a first passive roller that is in engagement with each first driver carried by said power shaft;
a second shaft parallel to said power shaft carrying a second passive roller that is in engagement with each second driver roller carried by said power shaft; and
a linkage for transferring power from said power source, to rotate said power shaft in a clockwise direction during said first operating mode, and to rotate said power shaft in a counterclockwise direction during said second operating mode.

6. The apparatus of claim 5, wherein:
said mechanism further comprises a device for locking each first driver roller for rotation with said power shaft during said first operating mode, and for locking each second driver roller for rotation with said power shaft during said second operating mode.

7. The apparatus of claim 6, wherein:
said locking device includes complementary key and key way components for each of said driver rollers carried on said power shaft, to selectively lock respective driver rollers for rotation with said power shaft.

8. The apparatus of claim 7, wherein:
each driver roller carried on said power shaft is mounted to rotate freely with respect to said power shaft, when not locked for rotation with said power shaft.

9. The apparatus of claim 5, wherein:
said power shaft carries a plurality of driver rollers for both said first and second roller sets.

10. The apparatus of claim 4, wherein said mechanism comprises:
a shaft supported for rotation carrying both said first and second paper rolls; and
a power mechanism for selectively rotating said shaft between first mode and second mode orientations, in order to position said first and second paper rolls, respectively, to supply paper to said printer.

11. The apparatus of claim 10, wherein:
said first and second roller sets are mounted for rotation with said shaft and with said paper rolls.

12. The apparatus of claim 11, wherein:
at least one driver roller of said first roller set is coupled to receive rotary power from said single power source, when said shaft is rotated to said first mode orientation, and at least one driver roller of said second set is coupled to receive rotary power from said single power source, when said shaft is rotated to said second mode orientation.

13. The apparatus of claim 10, wherein:
said shaft rotates through substantially 180° when rotating between said first and second mode orientations.

14. The apparatus of claim 4, wherein:
said apparatus supplies paper to a printer used at a specified point-of-sale terminal.

15. The apparatus of claim 4, wherein:
said apparatus supplies paper to a printer used in a specified data processing system.

16. For use with a printer disposed to receive printing paper from either a first paper roll or a second paper roll, a method for supplying paper to said printer comprising the steps of:
adapting first and second roller sets to supply paper to said printer from said first and second paper rolls, respectively, when said roller sets respectively receive power;
adapting said first roller set to receive power from a single power source during a first operating mode;
adapting said second roller set to receive power from said single source during a second operating mode;
monitoring the amount of paper remaining on the paper roll supplying the printer at a given time; and
changing from the operating mode at the given time to the other operating mode before said remaining amount is used up.

17. The method of claim 16, wherein:
a power shaft carrying at least one driver roller belonging to each of said first and second roller sets is provided; and
said power shaft is rotated in a clockwise direction during said first operating mode, and is rotated in a counterclockwise direction during said second operating mode.

18. The method of claim 17, wherein:
each first driver roller is locked for rotation with said power shaft during said first operating mode, and each second driver roller is locked for rotation with said power shaft during said second operating mode.

19. The method of claim 16, wherein:
a shaft carrying both said first and second paper rolls is supported for rotation; and
said shaft is rotated between first mode and second mode orientations, in order to position said first and second paper rolls, respectively, to supply paper to said printer.

20. The method of claim 19, wherein:
at least one driver roller of said first roller set is coupled to receive rotary power from said single power source, when said shaft is rotated to said first mode orientation, and at least one driver roller of said second set is coupled to receive rotary power from said single power source, when said shaft is rotated to said second mode orientation.
